(19) United States
(12) Patent Application Publication
(10) Pub. No.: US 2026/0028055 A1
(43) Pub. Date: Jan. 29, 2026

(54) Transfer Cart and Load Transfer Apparatus

(71) Applicant: Robert Bosch GmbH, Stuttgart (DE)

(72) Inventor: Robert Meitzler, JR., Warren, MI (US)

(21) Appl. No.: 18/812,226

(22) Filed: Aug. 22, 2024

Related U.S. Application Data
(60) Provisional application No. 63/676,163, filed on Jul. 26, 2024.

(51) Int. Cl. B62B 3/02; B60L 53/80

(52) U.S. Cl. CPC B62B 3/02; B60L 53/80

(57) ABSTRACT

A transfer apparatus comprised of a transfer cart and a primary cart, wherein the transfer cart and primary cart is configured to receive a load from the primary cart and vice-versa. The transfer cart comprises a frame and a plurality of members providing support, including cross members that can be decoupled to fold the frame into a more compact arrangement. The apparatus may additionally comprise one or more load adapters to optimize the transfer cart for use with loads of different dimensions.

### TECHNICAL FIELD

This disclosure relates to the repair and maintenance of vehicles, in particular electric vehicles and their associated batteries. More specifically, this disclosure relates to tools useful in the repair and maintenance of electrical vehicles and their associated batteries.

### BACKGROUND

Electric vehicles are becoming more popular as their versatility and reliability improves. Electric vehicles and their respective components still require servicing for repair and maintenance operations. Most electric vehicles feature a large, heavy battery suitable to drive the prime mover of the vehicle, which often must be removed from the chassis of the vehicle to perform certain important servicing to the vehicle or to the battery itself.

Because of their size and weight, removal of the batteries from their respective chassis is often difficult and time-consuming, and may require specialized tools in a specialized shop environment. Such tools are often expensive, cumbersome, and difficult to store.

### SUMMARY

One aspect of this disclosure is directed to a transfer cart suitable to receive a load from an external cart. The transfer cart comprises a frame having a proximal end, a distal end, a plurality of lower support members, a plurality of upper support members, a plurality of brace members, and a number of cross members. The transfer cart additionally comprises a plurality of wheels coupled to the frame. The frame additionally comprises a longitudinal axis extending between the proximal end and the distal end. The plurality of lower support members extend in a direction parallel to the longitudinal axis. The plurality of upper support members are parallel to the plurality of lower support members. Each of the brace members extend between a lower support member and an upper support member. Each of the cross members extend between brace members. Each of the upper support members comprises a support surface, the support surface suitable to receive an external load. Each of the cross members extends between brace members that are disposed at least as close to the proximal end as the distal end.

Another aspect of this disclosure is directed to a load transfer apparatus comprising a primary cart and a transfer cart. The primary cart has a load receiver and a primary cart body, wherein the load receiver being height-adjustable and the primary cart body having a body width. The transfer cart has a frame and a plurality of wheels coupled to the frame. The frame is comprised of a proximal end and a distal end, with a longitudinal axis extending between the proximal end and the distal end. The frame is further comprised of a plurality of lower support members, a plurality of upper support members, a plurality of brace members, and a number of cross members. The plurality of lower support members extend in a direction parallel to the longitudinal axis. The plurality of upper support members extend in parallel to the plurality of lower support members. Each of the brace members extend between a lower support member and an upper support member. Each of the cross members extend between brace members. Each of the upper support members comprises a support surface, the support surface suitable to receive an external load from the primary cart. Each of the cross members extends between brace members that are disposed at least as close to the proximal end as the distal end. During transfer of a load, the distance between the upper support members is at least as wide as the body width. During transfer of a load, the load receiver is disposed at a height no lower than a height of the support surfaces.

The above aspects of this disclosure and other aspects will be explained in greater detail below with reference to the attached drawings.

### BRIEF DESCRIPTION OF THE DRAWINGS

FIG. 1 is an illustration of a load transfer apparatus comprising a primary cart and a transfer cart.

FIG. 2 is an alternate view of the primary cart depicted in FIG. 1.

FIG. 3 is an alternate view of the transfer cart depicted in FIG. 1.

FIG. 4 is a close-up view of a portion of the transfer cart depicted in FIG. 3.

FIG. 5 is an illustration of a transfer cart in a folded arrangement.

FIG. 6 is a close-up view of a portion of the transfer cart depicted in FIG. 3.

FIG. 7 is an illustration of a transfer cart outfitted with a number of load adapters.

FIG. 8 is an illustration of a transfer apparatus in a first state during a load transfer operation.

FIG. 9 is an illustration of a transfer apparatus in a second state during a load transfer operation.

FIG. 10 is an illustration of a transfer cart in a final state after the completion of a load transfer operation.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

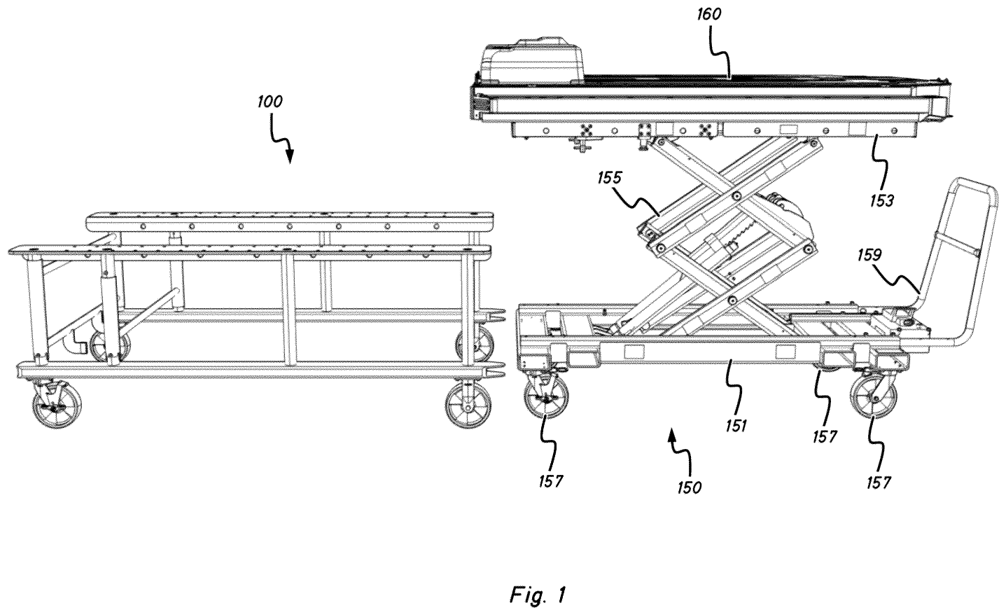

FIG. 1 is an illustration of a load transfer apparatus for use in vehicle service. The load transfer apparatus includes a transfer cart 100 and a primary cart 150. During the course of service, primary cart 150 may receive a load from a vehicle, or may receive a load as part of service, and transfer cart 100 may receive the load, thus advantageously permitting primary cart 150 to receive an additional load. This effectively allows two heavy loads to be supported by the load transfer apparatus. Transfer cart 100 is advantageously less expensive to produce than primary cart 150, so alternately a transfer apparatus may include multiple transfer carts 100 and a single primary cart 150, reducing the total cost for a working environment by minimizing the number of relatively expensive primary carts 150.

Primary cart 150 comprises a cart body 151, a load receiver 153, and a load lift 155. Cart body 151 provides structural support for primary cart 150 as well as other components of the cart. Load receiver 153 provides a surface that can receive an external load. In the depicted embodiment, load receiver 153 comprises a flat surface suitable to receive a wide variety of loads, but other embodiments may comprise different configurations with more specialized configurations without deviating from the teachings disclosed herein. The relative height of load receiver 153 is adjustable using a load lift 155. In the depicted embodiment, load lift 155 comprises a hydraulic scissor lift, but other embodiments may comprise other configurations without deviating from the teachings disclosed herein. In the depicted embodiment, the height of load receiver 153 may be adjusted by extending or contracting load lift 155, which advantageously permits a user to safely transfer loads to and from primary cart 150 while maintaining steady contact with the associated load. Primary cart 150 additionally comprises a number of wheels 157 and a handle 159, each of which provide ergonomic means for a user to move and position primary cart 150.

In the depicted embodiment, primary cart 150 is encumbered by a load. In this depiction, the load is shown to be a battery 160 for an electric vehicle, but the transfer apparatus may be utilized with loads of different shapes, sizes, weights, or configurations without deviating from the teachings disclosed above.

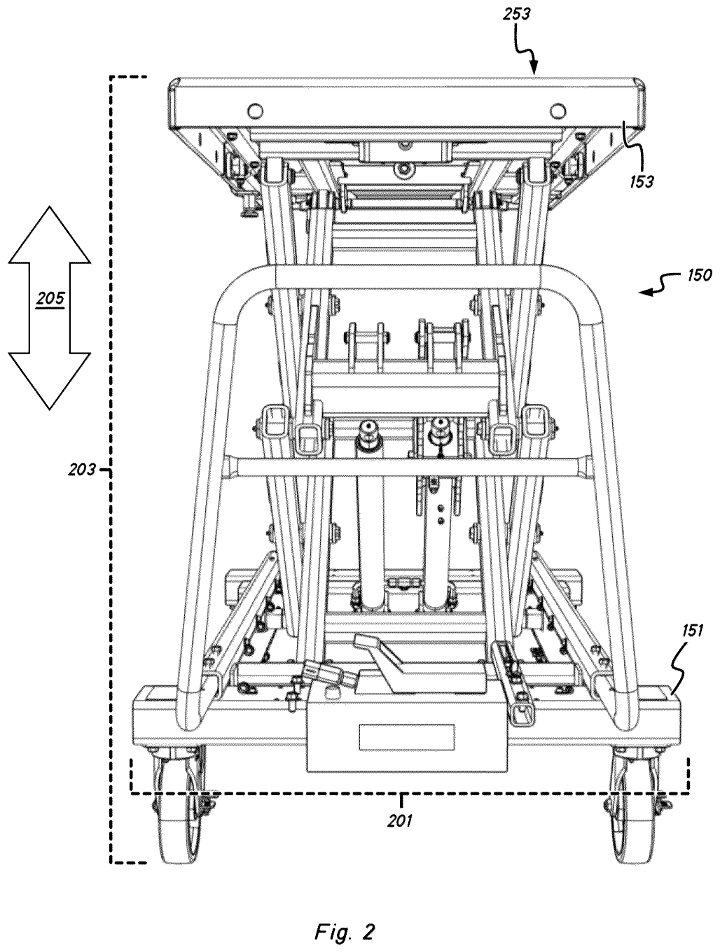

FIG. 2 is an alternate view of primary cart 150 (unencumbered) to illustrate additional features. In this view, it is observable that cart body 151 comprises a body width 201, which is measured at the widest point of primary cart 150. In the depicted embodiment, the widest point of primary cart 150 is near the bottom of cart body 151, but other embodiments may comprise other configurations without deviating from the teachings disclosed herein.

Additionally, it is observed that the height 203 of the load receiver is adjustable in a direction 205 and measured from the highest point of load receiver 153. In the depicted embodiment, the highest point of load receiver 153 is defined by a load-bearing surface 253, which makes contact with a received load during support of the load, but other embodiments may comprise other configurations without deviating from the teachings disclosed herein. The adjustability of height 203 permits primary cart 160 to engage with a variety of loads in a variety of operating conditions.

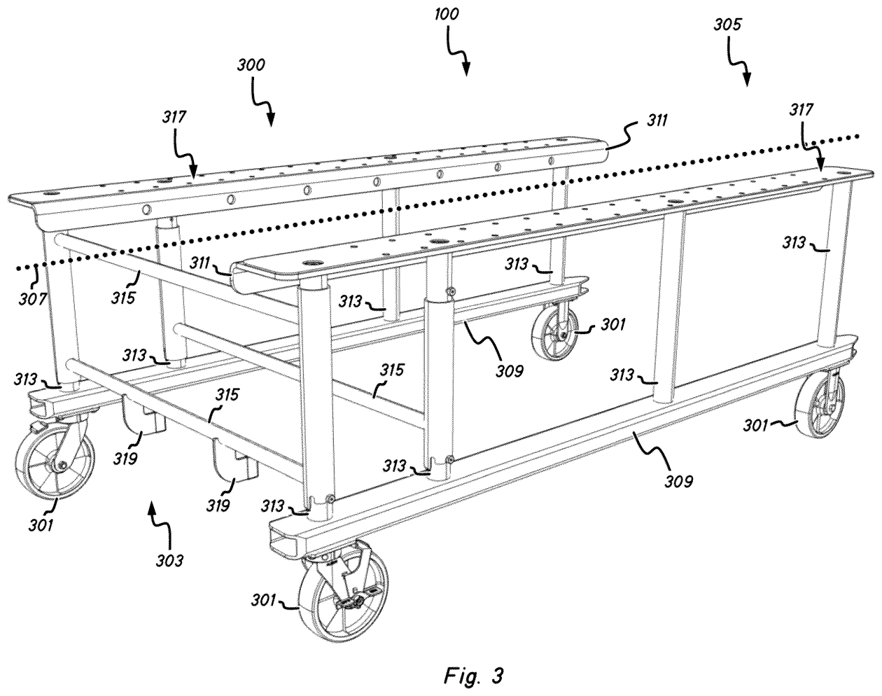

FIG. 3 is an alternate depiction of transfer cart 100. Transfer cart 100 comprises a frame 300 and a number of wheels 301. In the depicted embodiment, wheels 301 comprise multi-direction casters with lever brakes, but other embodiments may comprise other configurations without deviating from the teachings disclosed herein. In some embodiments, one or more of wheels 301 may comprise an alternative configuration without a brake without deviating from the teachings disclosed herein. In some embodiments, transfer cart 100 may not comprise wheels 301 without deviating from the teachings disclosed herein.

Frame 300 comprises a proximal end 303 and a distal end 305 disposed at opposite sides of transfer cart 100 along a longitudinal axis 307. Frame 300 comprises a plurality of lower support members 309, each of the lower support members 309 running from proximal end 303 to distal end 305 in a direction parallel to longitudinal axis 307. A plurality of upper support members 311 additionally disposed in parallel to the lower support members 309. Extending between the lower support members 309 and upper support members 311 are a number of brace members 313. The lower support members 309, upper support members 311, and brace members 313 form the primary structural supports of frame 300 when transfer cart 100 receives an external load. Additional structural stability is achieved by a number of cross members 315, each of the cross members 315 extending between brace members 313. The cross members 315 provide additional structural integrity for transfer cart 100 during receiving of a load. In particular, the cross members 315 provide structural integrity to forces experienced perpendicularly to those experienced by the brace members 313, improving the integrity and safety of frame 300.

Upper support members 313 each comprise a support surface 317, which is suitable to receive an external load and maintain contact with an external load that has a dimension at least as wide as the length of the cross members 315. In the depicted embodiment, cross members 315 only extend between brace members 313, but other embodiments may comprise other configurations without deviating from the teachings disclosed herein. In the depicted embodiment, each of cross members 315 extends between brace members 313 that are disposed nearer to proximal end 303 than distal end 305. This advantageously leaves unobstructed space between the lower support members 309 and upper support members 311 near the distal end 305, which optimizes the ability of the transfer cart 100 to engage with primary cart 150 (not shown; see FIG. 1) during a transfer by receiving the cart body 151 between the support members during a transfer of a load.

In the depicted embodiment, frame 300 additionally comprises a number of stoppers 319, suitable to engage with primary cart 150 (see FIG. 1) to prevent damage to primary cart 150 and transfer cart 100 during a transfer of a load between carts. Stoppers 319 additionally advantageously provide a safe mechanism for a user to know when the carts have been positioned closely enough for a safe transfer: when the primary cart 150 makes contact with stoppers 319, a sufficiently close placement has been achieved. In the depicted embodiment, transfer cart 100 comprises two stoppers 319 coupled to one of cross members 315, but other embodiments may comprise other arrangements or configurations without deviating from the teachings disclosed herein.

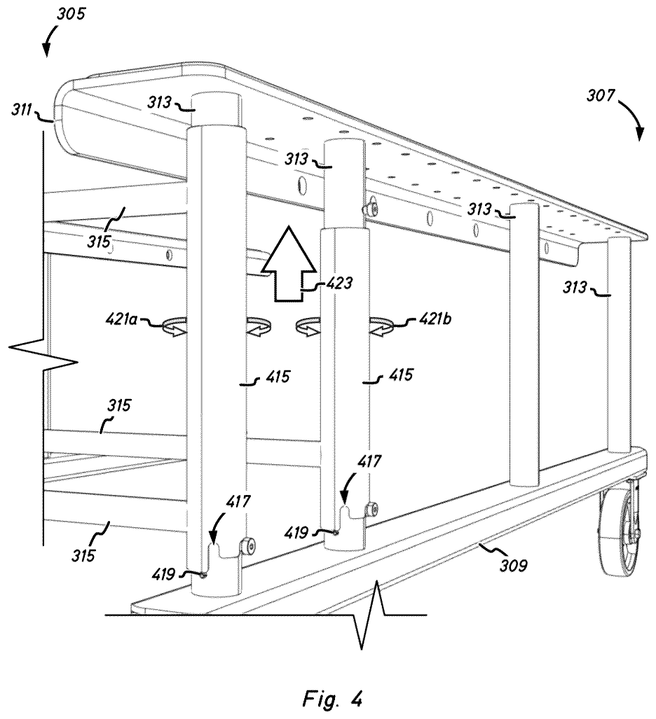

Additional features of cross members 315 are illustrated in a close-up view provided by FIG. 4. In particular, each of cross members 315 are detachably coupled to at least one of their associated brace members 313 utilizing a rotating sleeve coupling 415. The rotating sleeve coupling 415 comprises a quick release mechanism having a lock notch 417 and a quick release pin 419. In the depicted embodiment, each of the sleeve couplings 415 may be lifted in an upward direction 423 to release quick release pin 419 from lock notch 417, permitting the now-detached sleeve coupling 415 to rotate in a direction 421 about an axis defined by the longitudinal extension of its respective brace member 313. When the desired orientation of the sleeve coupling 415 is reached, the sleeve coupling 415 may be lowered to lock back into a coupled position by seating quick release pin 419 back into lock notch 417.

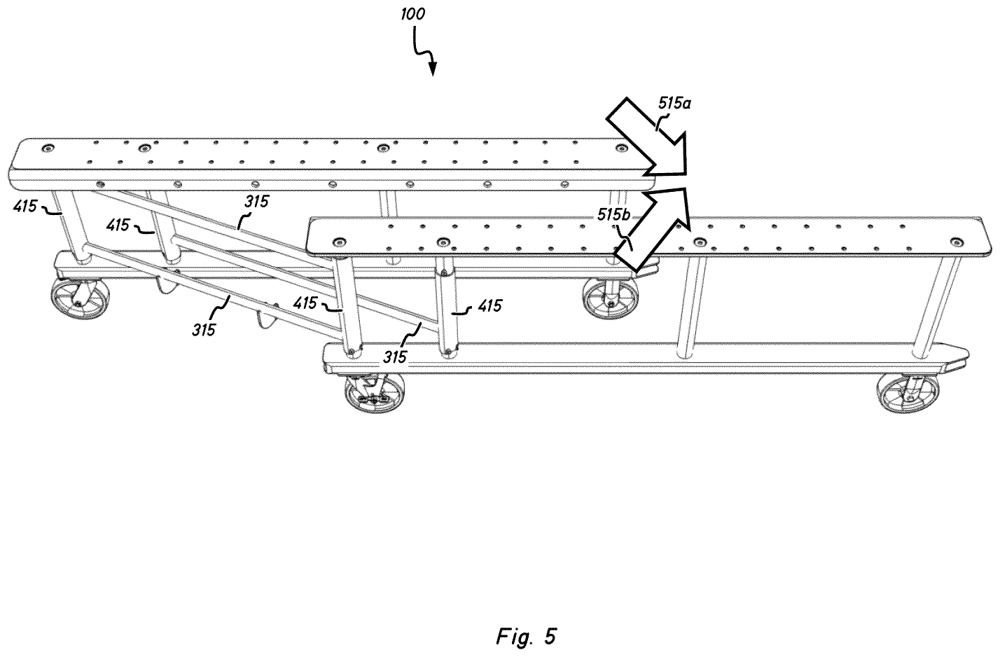

FIG. 5 is an overhead view of transfer cart 100 in an alternative configuration where one or more of sleeve couplings 415 have been de-coupled. In this configuration, each set of support members (see FIG. 1) on either side of cross members 315 are able to move in a compressive direction 515, permitting transfer cart 100 to “fold” into a more compact folded arrangement for storage or transport. The configuration may be reversed again by moving the sleeve couplings 415 back into the locked position (see FIG. 4). This advantageously permits a user to configure the arrangement of transfer cart 100 for use by engaging the quick release pin 419 (see FIG. 4) in the lock notch 417 (see FIG. 4), which in the depicted embodiment necessitates “unfolding” the transfer cart 100. This is additionally advantageous because it requires a user to place the transfer cart 100 into the locked position to achieve a stable and structurally sound configuration before use during a transfer of a load.

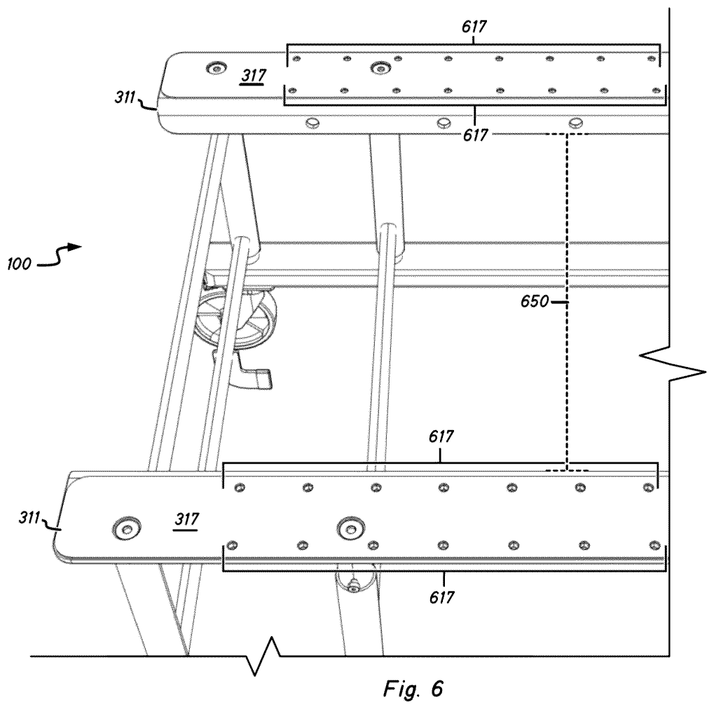

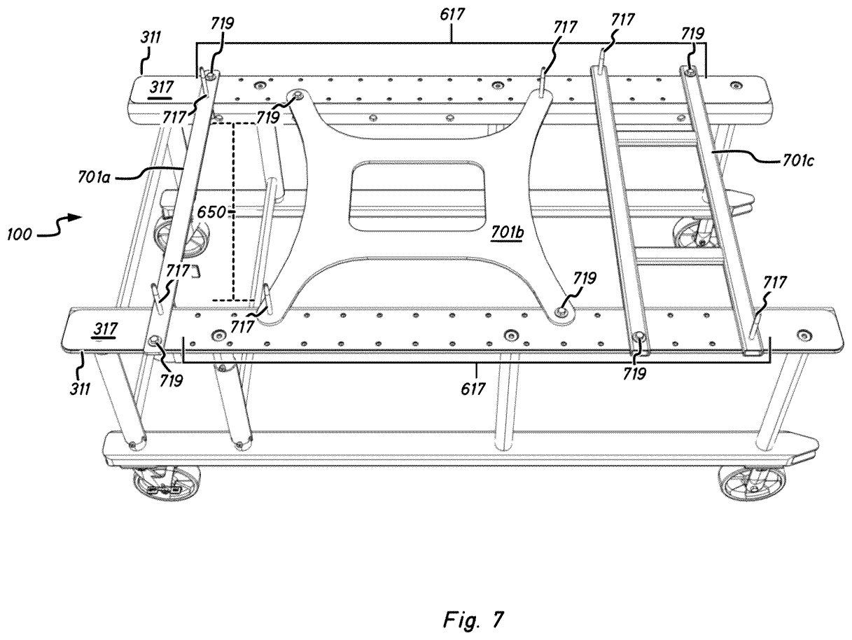

FIG. 6 is a close-up illustration of transfer cart 100, showing additional features of support surfaces 317. In particular, each of support surfaces 317 comprises a series of mounting mechanisms 617. In the depicted embodiment, each of the mounting mechanisms may comprise a guide hole 617 suitable for engaging a guide pin (not shown; see FIG. 7), but other embodiments may comprise other mounting mechanism configurations in addition to or instead of guide holes without deviating from the teachings disclosed herein. Mounting mechanisms 617 advantageously permit additional attachments to be used with transfer cart 100, which can advantageously configure the cart to receive loads having dimensions smaller than the gap 650 between the support surfaces 317. In the depicted embodiment, gap 650 is a distance from 28 inches to 37 inches wide, such as 33.25 inches. Other embodiments may comprise other configurations without deviating from the teachings disclosed herein.

FIG. 7 is an illustration of a number of load adapters 701 suitable for receiving loads having dimensions smaller than the gap 650 of primary cart 100. Each of load adapters 701a, 701b, and 701c are mounted to support surfaces 317 and coupled using one or more fasteners engaging with one of guide holes 617. The fasteners depicted include a guide pin 717 and a bolt 719, but other embodiments may comprise other fasteners without deviating from the teachings disclosed herein. Each of load adapters 701 may be used alone, in tandem with one or more other load adapters of a same configuration, or in tandem with one or more load adapters of multiple configurations without deviating from the teachings disclosed herein.

In the depicted embodiment, three different shapes of load adapters 701 are depicted. Load adapter 701a is a bar adapter that provides a support to a load across the width of gap 650. Load adapter 701a advantageously is the simplest to manufacturer and requires the least amount of space and mounting mechanisms 617 to secure, but also provides the narrowest amount of direct support for a load across gap 650. Load adapter 702b is an “x” support, providing a large area of support across gap 650, but also requiring the most open space along support surfaces 317 to securely fasten to the upper support members 311. Load adapter 701c is an “h” support, providing a pair of beams with additional cross-bar support elements. Load adapter 701c provides a moderate amount of support coverage across gap 650, while simultaneously requiring a moderate amount of free space to securely fasten to upper support members 311. Other embodiments may comprise other load adapters 701 having different configurations without deviating from the teachings disclosed herein.

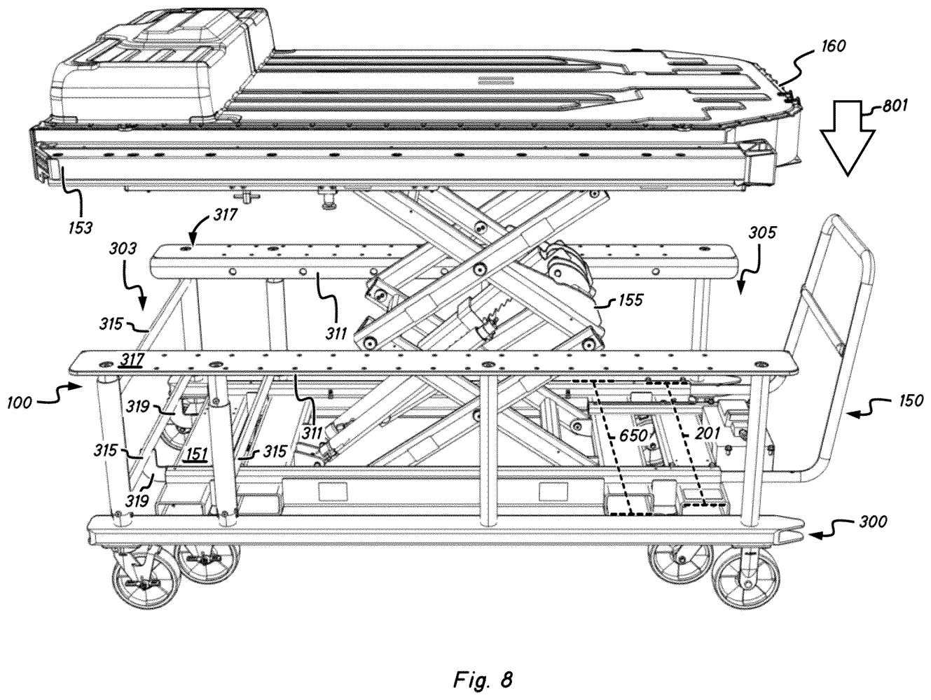

FIG. 8 is an illustration of a transfer of load 160 between primary cart 150 and transfer cart 100. In this depiction, the transfer process has been initiated, as primary cart has been positioned within frame 300 until cart body 151 has engaged with stoppers 319. The depicted embodiment, transfer cart 100 has been moved to this position relative to primary cart 150, but either cart may be positioned with respect to the other without deviating from the teachings herein. In this view, it can be observed that the gap 650 between opposite sides of the frame 300 is larger than body width 201 of primary cart 150. In the depicted embodiment, load 160 comprises an electric battery suitable for an electric vehicle and having a mass of 1400 kilograms, and accordingly both primary cart 150 and transfer cart 100 are specified to safely support 1400 kilograms, both while stationary and while being moved under load. Other embodiments may comprise different load specifications without deviating from the teachings disclosed herein. In the depicted embodiment, it is noted that the cross members 315 are disposed 17 inches apart to provide sufficient support for a load 160 having this weight. Other embodiments having different configurations and specification may have different arrangements without deviating from the teachings disclosed herein. In the depicted embodiment, load receiver 153 is at a first height, and will be moved in a direction 801 lower for transfer by compressing load lift 155.

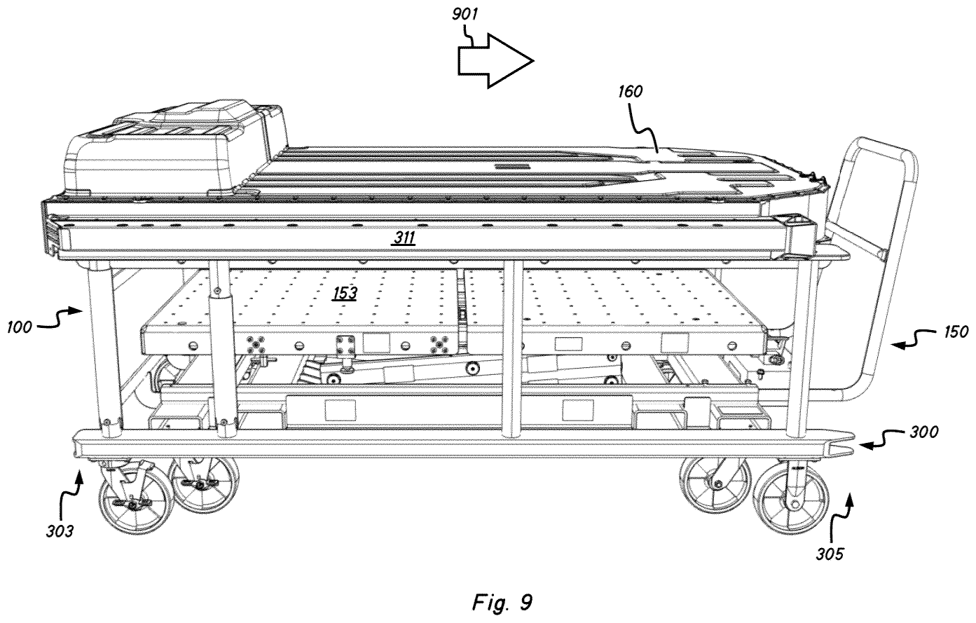

FIG. 9 is an illustration of the next phase of a transfer operation between the primary cart 150 and transfer cart 100. In this step, load receiver 153 has been lowered below the height of the upper support members 311, which has transferred the weight of load 160 onto primary cart 100 via support surfaces 317 (not visible; see FIG. 3, FIG. 8). With the weight of load 160 fully transferred onto transfer cart 100, primary cart 150 may be moved in a direction 901 to disengage with the transfer cart 100 and be used in other service. While in the depicted embodiment primary cart 150 is going to be moved to disengage the transfer operation, other embodiments may move transfer cart 100 instead without deviating from the teachings disclosed herein.

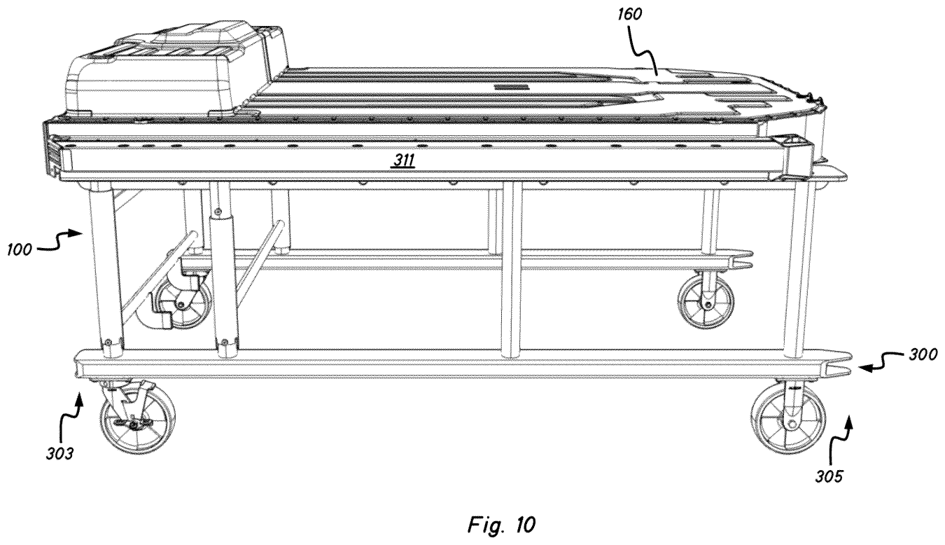

FIG. 10 shows transfer cart 100 supporting the load 160 after separation of primary cart 150 (not shown; see FIG. 1, FIG. 8, FIG. 9). This is the state of the transfer cart 100 after the completion of a transfer operation to receive the external load 160 from an external source (e.g., primary cart 150; see FIG. 1, FIG. 8, FIG. 9). Removal of load 160 from transfer cart can be accomplished in the reverse order, by introducing a primary cart disposed as depicted in FIG. 9, raising the associated load receiver until the load is transferred to the load receiver and off of support surfaces 317 (not visible; see FIG. 3, FIG. 8), and ultimately no load is supported by primary cart 100 any longer, similarly to FIG. 8. Other embodiments may comprise other configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts. Battery 160 may be transferred from primary cart 160 to transfer cart 100, which will later be described in greater detail.

What is claimed is:

1. A transfer cart comprising:
a frame having
a proximal end and a distal end,
a longitudinal axis extending between the proximal end and the distal end,
a plurality of lower support members extending in a direction parallel to the longitudinal axis,
a plurality of upper support members in parallel to the plurality of lower support members,
a plurality of brace members, each of the brace members extending between a lower support member and an upper support member, and
a number of cross members, each of the cross members extending between brace members; and
a plurality of wheels, each of the wheels coupled to a lower support member,
wherein
each of the upper support members comprises a support surface, the support surface suitable to receive an external load, and
each of the cross members extends between brace members that are disposed at least as close to the proximal end as the distal end.

2. The transfer cart of claim 1, wherein each of the cross members extend between the brace members that are disposed closer to the proximal end than the distal end.

3. The transfer cart of claim 1, wherein at least one support surface comprises a mounting mechanism.

4. The transfer cart of claim 3, wherein the mounting mechanism comprises a guide pin and at least one guide hole.

5. The transfer cart of claim 3, further comprising a load adapter coupled to the at least one support surface using the mounting mechanism, the load adapter transferring a received load to the at least one support surface when coupled to the at least one support surface.

6. The transfer cart of claim 5, wherein the plurality of support surfaces comprise a mounting mechanism, and wherein the load adapter is coupled to at least a subset of the plurality of support surfaces using the mounting mechanism of each respective support surface, the load adapter transferring a portion of the received load to each of the coupled support surfaces.

7. The transfer cart of claim 1, wherein the upper support members are disposed apart from each other at a distance of 28 inches to 37 inches.

8. The transfer cart of claim 1, wherein each of the cross members are detachably coupled to at least one of the respective brace members from which it extends.

9. The transfer cart of claim 8, wherein the distance between the upper support members is adjustable when each of the cross members is detached from at least one of the respective brace members from which it extends.

10. The transfer cart of claim 8, wherein the cross members are detachably coupled to respective brace members utilizing a quick release mechanism.

11. The transfer cart of claim 10, wherein the quick release mechanism comprises a quick release pin.

12. The transfer cart of claim 1, further comprising a stopper coupled to the frame, wherein during a transfer of a load from an external cart to the transfer car, the stopper limits the motion of the external cart.

13. The transfer cart of claim 1, wherein the transfer cart has a load capacity of at least 1400 kilograms.

14. A load transfer apparatus comprising:
a primary cart having a load receiver and a primary cart body, the load receiver being height-adjustable and the primary cart body having a body width; and
a transfer cart having
a frame comprised of
a proximal end and a distal end,
a longitudinal axis extending between the proximal end and the distal end,
a plurality of lower support members extending in a direction parallel to the longitudinal axis,
a plurality of upper support members in parallel to the plurality of lower support members,
a plurality of brace members, each of the brace members extending between a lower support member and an upper support member, and
a number of cross members, each of the cross members extending between brace members, and
a plurality of wheels, each of the wheels coupled to lower support member,
wherein
each of the upper support members comprises a support surface, the support surface suitable to receive an external load, and
each of the cross members extends between brace members that are disposed at least as close to the proximal end as the distal end,
wherein during transfer of a load, the distance between the upper support members is at least as wide as the body width, and
wherein during transfer of a load, the load receiver is disposed at a height no lower than a height of the support surfaces.

15. The transfer cart of claim 14, further comprising a stopper coupled to the frame, the stopper engaging with the primary cart body during a transfer of the load from the primary cart to the transfer cart.

16. The transfer cart of claim 14, wherein the upper support members are disposed apart from each other at a distance of 28 inches to 37 inches.

17. The transfer cart of claim 14, wherein each of the cross members are detachably coupled to at least one of the respective brace members to which it is coupled.

18. The transfer cart of claim 17, wherein the distance between the upper support members is adjustable when each of the cross members are detached from at least one of the respective brace members.

19. The transfer cart of claim 17, wherein the cross members are detachably coupled to respective brace members utilizing a quick release mechanism.

20. The transfer cart of claim 19, wherein the quick release mechanism comprises a quick release pin.
